(19) United States
(12) Patent Application Publication
(10) Pub. No.: US 2019/0059646 A1
(43) Pub. Date: Feb. 28, 2019

(54) HEATING COOKING DEVICE

(71) Applicant: SHARP KABUSHIKI KAISHA, Sakai City, Osaka (JP)

(72) Inventors: MASAYUKI UNO, Sakai City (JP); SHINJI ASAMI, Sakai City (JP)

(21) Appl. No.: 16/076,555

(22) PCT Filed: Jan. 23, 2017
(86) PCT No.: PCT/JP2017/002179

§ 371 Date: Aug. 8, 2018

(30) Foreign Application Priority Data
Apr. 15, 2016 (JP) 2016-082434

(51) Int. Cl. A47J 37/06; F24C 15/16; F24C 7/04

(52) U.S. Cl. CPC A47J 37/0629; F24C 7/04; F24C 15/16

(57) ABSTRACT

The present invention provides a cooking device (1) in which hot air is less likely to leak out of a cooking room. The cooking device (1) includes: a holding frame (15) which is moved in a state of being guided by guide grooves (21a); L-shaped levers (31) connected to the holding frame (15); straight levers (33) having rotation centers (33a) which are in agreement with rotation centers (31a) of the L-shaped levers (31) and are secured together with the L-shaped levers (31); and connecting bars (34) connected to the front door (14) and the corresponding straight levers (33).

### TECHNICAL FIELD

The present invention relates to a cooking device for cooking a food item.

### BACKGROUND ART

Conventionally, cooking devices, such as a toaster oven, for cooking a food item placed in a cooking room have been in widespread use. In such cooking devices, a food carrying member, such as a grill (see Patent Literature 1) and a cooking tray (see Patent Literature 2), for carrying a food item is provided in the cooking room. To facilitate placement of a food item on the food carrying member and accommodation of a food item in the cooking room, the food carrying member is permitted to advance and move out of the cooking room as a front door is opened, and to retract and move into the cooking room as the front door is closed.

Regarding the arrangement in which the food carrying member is advanced, Patent Literature 1 discloses the configuration in which left and right inner side wall members for forming a baking room have guide grooves. These guide grooves are formed in a horizontally long area in a state of penetrating the inner side wall members. In the baking room is provided a frame on which a grill or a cooking tray, which serves as the food carrying member, is to be placed. The frame has guide pins provided on the left and right parts thereof, wherein the guide pins penetrate the corresponding guide grooves and are each connected to one end of a corresponding one of arms which are provided on the outer sides of the inner side wall members. At the other end, the arms are connected to corresponding inner surfaces of the front door. Thus, when the door is opened, the arms are moved forward accordingly, and the guide pins are moved forward in a state of being guided by the guide grooves. Accordingly, the frame and the grill or the cooking tray on the frame are moved forward.

### CITATION LIST

### Patent Literature

### [Patent Literature 1]

Japanese Patent Application Publication Tokukai No. 2013-224807

### [Patent Literature 2]

Japanese Patent Application Publication Tokukai No. 2003-120944

### SUMMARY OF INVENTION

### Technical Problem

Unfortunately, the configuration disclosed in Patent Literature 1 is such that in order to move back and forth the frame on which the food carrying member is placed as the front door is opened and closed, the guide grooves are formed in the state of penetrating the inner side wall members, and the guide pins formed on the frame pass through the corresponding guide grooves and are connected to the corresponding arms provided on the outer sides of the inner side wall members.

Thus, during cooking of a food item, hot air in the cooking room leaks out through the guide grooves into a wall-to-wall space between the inner side wall members and an outer wall member that constitutes a housing. This decreases a heating efficiency. Further, the hot air contains steam generated from the food item, and a current-carrying part of an electrical system is usually present in the wall-to-wall space. In this situation, the current-carrying part is more likely to be corroded and/or short-circuited due to the steam.

Thus, it is an object of the present invention to provide a cooking device in which hot air generated during cooking of a food item is less likely to leak out of a cooking room.

### Solution to Problem

In order to solve the above problem, a cooking device in accordance with an aspect of the present invention is a cooking device including (i) a heating device configured to heat an interior of a cooking room and (ii) a door configured to swing about a lower portion of the door to open and close the interior of the cooking room, the cooking device including: guide grooves, provided on two opposite side walls of the cooking room, extending in a front-to-rear direction; a food carrying member configured to be moved in a state of being guided by the guide grooves or a holding frame on which the food carrying member is to be placed; first members, provided on the corresponding side walls, having their respective first ends and second ends, the first ends having respective rotation centers about which the first members rotate, the second ends being connected to the food carrying member or the holding frame; second members, provided on the corresponding side walls, having their respective first ends, the first ends having respective rotation centers about which the second members rotate, the rotation centers being in agreement with the rotation centers of the first members, the rotation centers being secured together with the first members; and third members having their respective first ends and second ends, the first ends being connected to the door, the second ends being connected to the corresponding second ends of the second members.

### Advantageous Effects of Invention

According to the aspect of the present invention, the guide grooves for guiding movement of the holding frame are not required to have holes penetrating the side walls. This yields the effect of making hot air generated during cooking of a food item less likely to leak out of the cooking room.

### BRIEF DESCRIPTION OF DRAWINGS

FIG. 1 is a perspective view illustrating a cooking device in accordance with an embodiment of the present invention with a front door is in an open position, when viewed at an angle from above and from the front.

FIG. 2 is a perspective view illustrating the cooking device illustrated in FIG. 1 with the front door is in a closed position, when viewed at an angle from above and behind.

FIG. 3 is a perspective view illustrating a grill for use in the cooking device illustrated in FIG. 1.

FIG. 4 is a perspective view illustrating a cooking tray for use in the cooking device illustrated in FIG. 1.

(a) of FIG. 5 is a plan view of a holding frame of the cooking device illustrated in FIG. 1, and (b) of FIG. 5 is a front elevational view of the holding frame.

FIG. 6 is a perspective view illustrating placement of the holding frame in the cooking room illustrated in FIG. 1, when viewed at an angle from above and behind the cooking device.

FIG. 7 is a perspective view illustrating the relationship between the holding frame illustrated in FIG. 6 and a corresponding one of engagement members and a corresponding one of L-shaped levers.

FIG. 8 is a perspective view illustrating the cooking device illustrated in FIG. 1 with the front door in an open position, when viewed at an angle from above and behind.

FIG. 9 is a perspective view illustrating a cooking device in accordance with another embodiment of the present invention in a state in which a grill is placed on a holding frame.

FIG. 10 is a perspective view illustrating the cooking device in accordance with the another embodiment of the present invention in a state in which the cooking tray is placed on the holding frame.

FIG. 11 is a perspective view illustrating a state in which the grill is placed on the cooking tray for use in the above cooking device.

FIG. 12 is a perspective view illustrating the cooking device in accordance with the another embodiment of the present invention in a state in which the cooking tray and the grill in the state illustrated in FIG. 11 is placed on the holding frame.

FIG. 13 is a perspective view illustrating a cooking device in accordance with still another embodiment of the present invention in a state in which the front door is removed.

FIG. 14 is a perspective view illustrating a drive mechanism and a holding frame both of which are included in a cooking device in accordance with yet another embodiment of the present invention.

FIG. 15 is an enlarged perspective view illustrating the structure of a connecting part between the drive mechanism and the holding frame illustrated in FIG. 14.

FIG. 16 is a perspective view illustrating a state in which a grill, which serves as a food carrying member, is placed on the holding frame illustrated in FIG. 14.

FIG. 17 is a longitudinal sectional view illustrating a state in which a cooking tray, which serves as a food carrying member, is placed on the holding frame illustrated in FIG. 14.

### DESCRIPTION OF EMBODIMENTS

### Embodiment 11

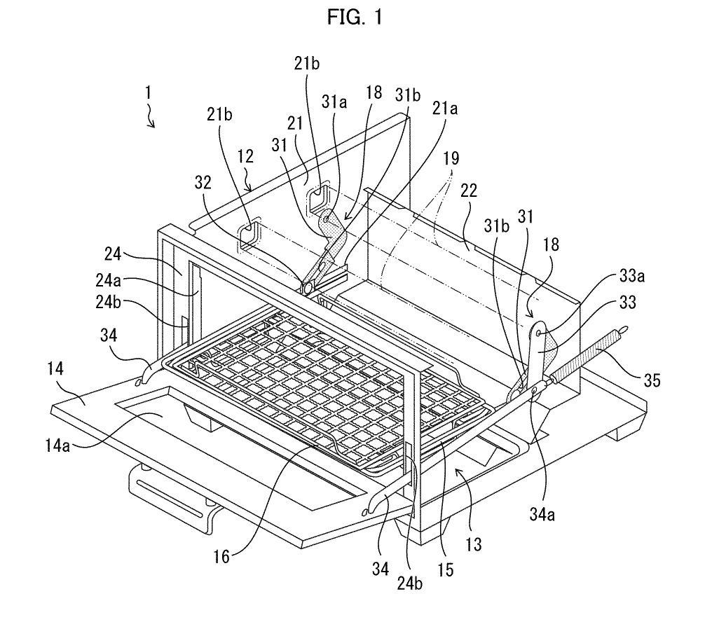

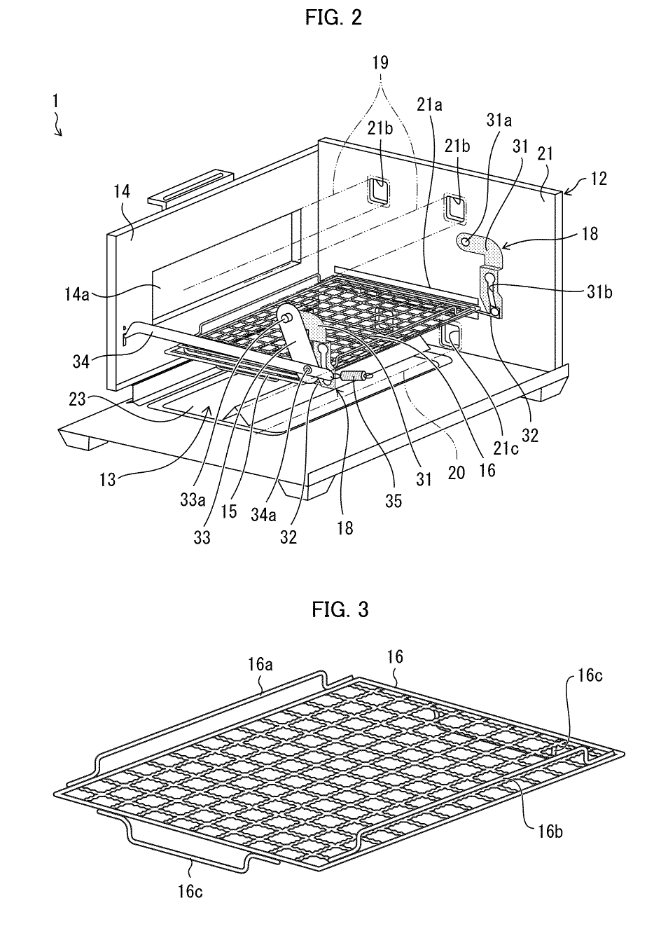

The following will describe embodiments of the present invention with reference to drawings. In Embodiment 1, the following descriptions will discuss an example case in which a cooking device in accordance with an embodiment of the present invention is applied to a toaster oven. In order to make it easier to understand the structure of the cooking device, FIG. 1 illustrates a state in which outer walls constituting a housing of the cooking device are removed, and, of all inner walls forming a cooking room, a top wall and a side wall on the right as seen from the front of the cooking device are removed. FIGS. 2, 6, and 8 each illustrate a state in which outer walls constituting a housing of the cooking device are removed, and, of all inner walls forming a cooking room, a top wall, a side wall on the right as seen from the front of the cooking device, and a rear wall are removed.

(Configuration of Cooking Device)

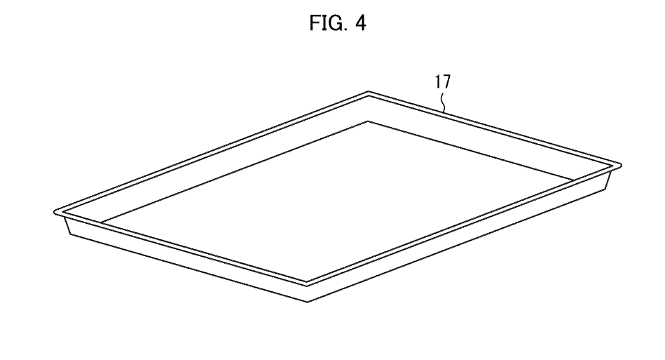

FIG. 1 is a perspective view illustrating a cooking device in accordance with Embodiment 1 with a front door in an open position, when viewed at an angle from above and from the front. FIG. 2 is a perspective view illustrating the cooking device with the front door in a closed position, when viewed at an angle from above and behind. FIG. 3 is a perspective view illustrating a grill for use in the cooking device illustrated in FIG. 1. FIG. 4 is a perspective view illustrating a cooking tray for use in the cooking device illustrated in FIG. 1.

As illustrated in FIGS. 1 and 2, the cooking device 1 has, on the inner side of the outer walls (not illustrated) constituting the housing of the cooking device 1, inner walls 12 with which a cooking room 13 is surrounded. The inner walls 12 have left and right side walls 21, a rear wall 22, a bottom wall 23, and a top wall (not illustrated).

In front of the cooking room 13, a front frame 24 is provided. An inner surface of the front frame 24 is in contact with the left and right side walls 21, the rear wall 22, the bottom wall 23, the top wall, and the outer walls at their front-end edges. The front frame 24 includes an opening 24a through which a food item can be taken in or out of the cooking room 13.

On the front frame 24, a front door 14 for opening and closing an opening 24a is provided so as to be freely opened and closed. The front door 14 is secured to a lower portion of the front frame 24 so as to swing upward and downward about the lower portion of the front door 14. The front door 14 in a closed position covers the opening 24a of the front frame 24 and surroundings of the opening 24a, thereby blocking the opening 24a. In the center of the front door 14, a viewing window 14a made of a heat-resistant glass is provided.

Inside the cooking room 13, a rectangular holding frame 15 is provided. On the holding frame 15 is placed a food carrying member, i.e., a grill 16 illustrated in FIG. 3 or a cooking tray 17 illustrated in FIG. 4. As illustrated in FIG. 3, the grill 16 has a front upwardly raised part 16a at a front edge thereof, a rear upwardly raised part 16b at a rear edge thereof, and lateral downwardly raised parts 16c at left and right edges thereof. The grill 16 and the cooking tray 17 are provided in the cooking device 1.

The front upwardly raised part 16a and the rear upwardly raised part 16b serve as stoppers for preventing a food item placed on the grill 16 from coming off the grill 16. Upwardly raised parts, which correspond to the front upwardly raised part 16a and the rear upwardly raised part 16b, may be provided at positions on the left and right sides of the grill 16. The lateral downwardly raised parts 16c, which are fit in the holding frame 15, have the function of performing positioning of the grill 16 on the holding frame 15.

(Configuration of Holding Frame)

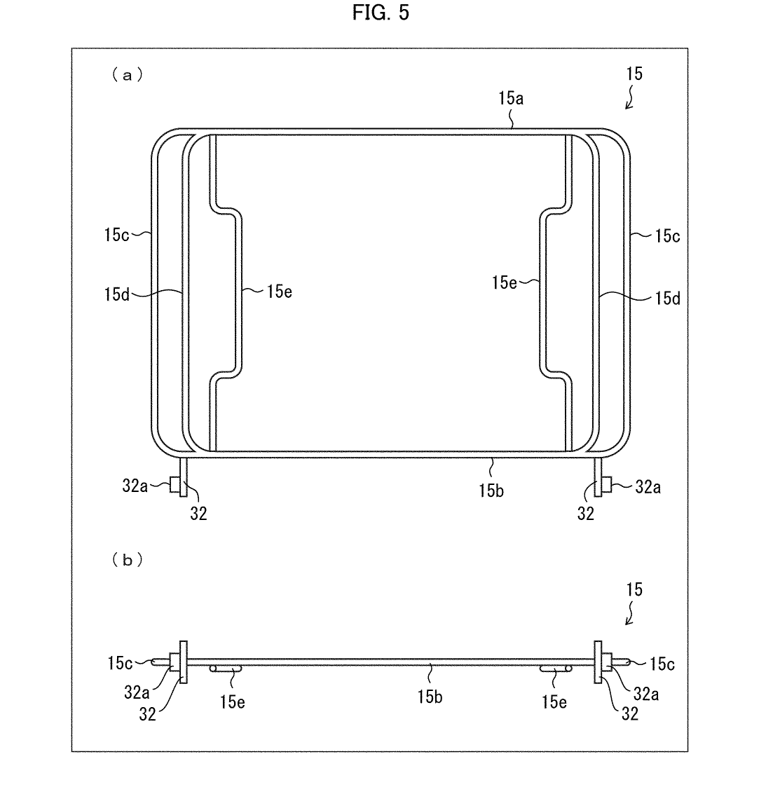

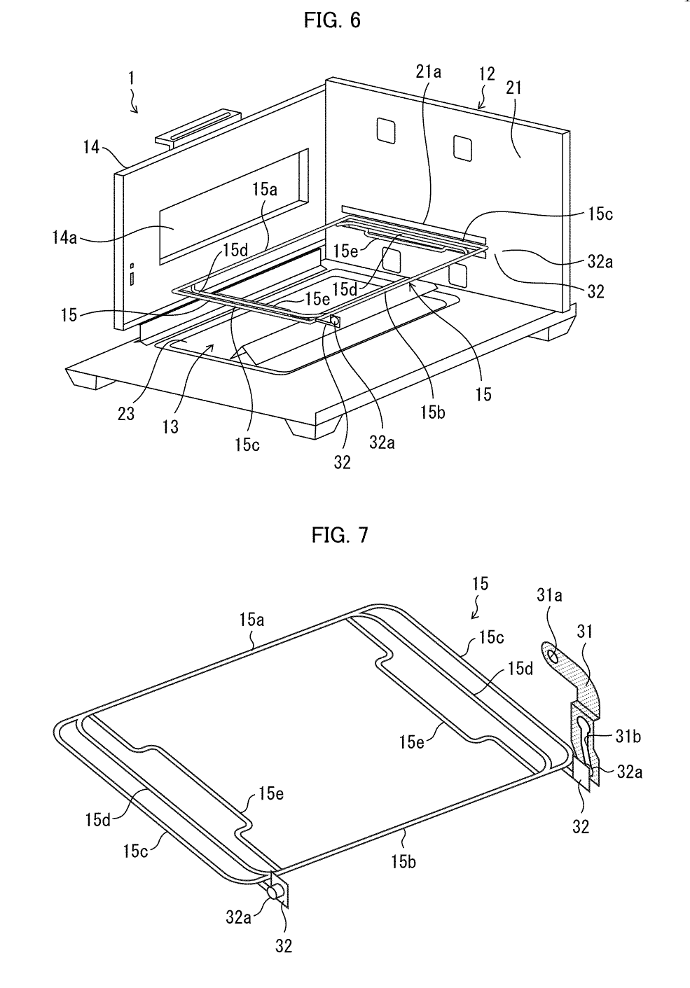

(a) of FIG. 5 is a plan view of the holding frame 15 of the cooking device 1 illustrated in FIG. 1, and (b) of FIG. 5 is a front elevational view of the holding frame 15. FIG. 6 is a perspective view illustrating placement of the holding frame 15 in the cooking room 13, when viewed at an angle from above and behind the cooking device 1. Note that, for simplicity of the drawing, FIG. 6 omits the drive mechanism 18.

The holding frame 15 has a frame front part 15a, a frame rear part 15b, and left and right frame lateral parts 15c, as illustrated in FIGS. 5 and 6. Further, the holding frame 15 has, at the positions on the left and right sides, (i) a single pair of tray holding parts 15d extending from the frame front part 15a to the frame rear part 15b and (ii) a single pair of grill holding parts 15e extending from the frame front part 15a to the frame rear part 15b. The grill holding parts 15e are located on inner sides of the holding frame 15 with respect to the tray holding parts 15d. As illustrated in (b) of FIG. 5, the grill holding parts 15e are provided, for example, at positions lower by a step equivalent of the diameter of the frame front part 15a than the frame front part 15a, the frame rear part 15b, the frame lateral parts 15c, and the tray holding parts 15d. Further, a space (downwardly raised part inserted area) is formed between a corresponding one of the grill holding parts 15e and a corresponding one of the tray holding parts 15d.

In a case where the cooking tray 17 is placed on the holding frame 15, the frame front part 15a, the frame rear part 15b, and the tray holding parts 15d are brought into contact with outer surfaces of the cooking tray 17. Thus, positioning of the cooking tray 17 is performed by the holding frame 15. Note that the grill holding parts 15e may be arranged so as to be brought into contact with a lower surface of the cooking tray 17.

A corresponding one of the lateral downwardly raised parts 16c of the grill 16 can be inserted into a space between a corresponding one of the grill holding parts 15e and a corresponding one of the tray holding parts 15d. Thus, in a state in which the grill 16 is placed on the holding frame 15, and a corresponding one of the lateral downwardly raised parts 16c of the grill 16 is inserted into a space between a corresponding one of the grill holding parts 15e and a corresponding one of the tray holding parts 15d, the holding frame 15 can hold the grill 16 in a state in which the grill 16 is less likely to move.

(Movement Guide Structure of Holding Frame)

As illustrated in FIG. 6, the left and right side walls 21 of the inner walls 12 of the cooking device 1 has the corresponding guide grooves 21a extending horizontally in the front-to-rear direction without cutting the side walls 21 (without forming through holes through the side walls 21). The guide grooves 21a are formed by, for example, drawing of the side walls 21. Alternatively, the guide grooves 21a may be formed by, for example, welding or bonding members corresponding to the guide grooves 21a onto the side walls 21.

The frame lateral parts 15c of the holding frame 15 are fit into the guide grooves 21a. Thus, the holding frame 15 can be guided by the guide grooves 21a so as to be freely moved in the front-to-rear direction of the cooking device 1.

(Configuration of Drive Mechanism)

FIG. 7 is a perspective view illustrating the relationship between the holding frame 15 illustrated in FIG. 6 and a corresponding one of engagement members 32 and a corresponding one of L-shaped levers 31.

The cooking device 1 includes a drive mechanism 18, as illustrated in FIGS. 1 and 2. The holding frame 15 in a state of being guided by guide grooves 21a is driven by the drive mechanism 18 so as to move in a front-to-rear direction of the cooking device 1.

The drive mechanism 18 includes L-shaped levers (first members) 31, engagement members 32, straight levers (second members) 33, connecting bars (third members) 34, and coil springs 35.

The L-shaped levers 31, which are provided along corresponding inner surfaces of the left and right side walls 21, are rotatably secured to the corresponding inner surfaces of the left and right side walls 21 at positions above the rear ends of the guide grooves 21a. Specifically, the L-shaped levers 31 are permitted to rotate about their respective rotation centers 31a which are provided in upper parts thereof. As is illustrated in FIG. 7, the L-shaped levers 31 are each shaped in the letter of L with bends formed such that lower parts extend forward with respect to the upper parts. The lower parts each have long holes 31b that extend in lengthwise directions thereof.

The engagement members 32 are provided at the left and right ends of the rear edge of the holding frame 15 so as to protrude rearward from the holding frame 15. The engagement members 32 have their respective engagement protrusions 32a that protrude in different directions so as to face the corresponding side walls 21, i.e., the corresponding L-shaped levers 31. The engagement protrusions 32a are inserted into the corresponding long holes 31b of the L-shaped levers 31. The long holes 31b are provided such that forward rotation of the L-shaped levers 31 from the downward positions pushes the corresponding engagement protrusions 32a forward, whereas downward rotation of the L-shaped levers 31 from the forward positions pushes the corresponding engagement protrusions 32a rearward.

The straight levers 33 are provided along corresponding outer surfaces of the left and right side walls 21 at positions facing the corresponding L-shaped levers 31 via the side walls 21. The straight levers 33 have their respective rotation centers 33a provided in upper parts thereof. The rotation centers 33a are in agreement with the rotation centers 31a of the L-shaped levers 31, and the rotation centers 33a and 31a are secured with, for example, bolts and nuts. Thus, the straight levers 33 and the L-shaped levers 31 are integrally rotated about the rotation centers 33a and 31a.

The connecting bars 34 are provided so as to extend in the front-to-rear direction along the outer surfaces of the left and right side walls 21. Each of the connecting bars 34 has a front end part and a rear end part, wherein the front end part penetrates the front frame 24 and is rotatably connected to the front door 14, and the rear end part is connected to a lower end part of the straight lever 33 so as to be pivotable about the connecting part 34a. In the front frame 24, areas which the connecting bars 34 penetrate are connecting bar through holes 24b (see FIG. 1), which are blocked by the front door 14 in a closed position.

The coil springs 35 are provided behind the corresponding connecting bars 34. The coil springs 35 have (i) their respective front ends connected to the corresponding rear ends of the connecting bars 34 and (ii) their respective rear ends connected to, for example, a rear wall part of the outer walls of the cooking device 1.

(Other Features of Configuration of Cooking Device)

Each of the left and right side walls 21 has two upper heater attachment holes 21b which are provided above the holding frame 15 and are arranged side by side in the front-to-rear direction. Similarly, each of the left and right side walls 21 has two lower heater attachment holes 21c which are provided below the holding frame 15 and are arranged side by side in the front-to-rear direction. Through the opposed upper heater attachment holes 21b of the left and right side walls 21, the upper heaters 19 are provided so as to extend to the left and right, as indicated by two-dot chain lines in FIGS. 1 and 2. Similarly, through the opposed lower heater attachment holes 21c of the left and right side walls 21, the lower heaters 20 are provided so as to extend to the left and right, as indicated by two-dot chain lines in FIG. 2. The upper heater attachment holes 21b and the lower heater attachment holes 21c are blocked by attachment of the upper heaters 19 and the lower heater 20 therethrough.

As described above, the cooking device 1 is configured such that the guide grooves 21a for guiding movement of the holding frame 15 are provided without having holes that pass through the side walls 21. Further, the upper heater attachment holes 21b and the lower heater attachment holes 21c of the side walls 21 are blocked by provision of the upper heaters 19 and the lower heater 20. Still further, the connecting bar through holes 24b are blocked by the front door 14 when the front door 14 is in a closed position. Yet further, the side walls 21 have no holes or openings that pass through the side walls 21 and are kept open.

The following will describe operations of the cooking device 1 configured as above.

(Use of Grill or Cooking Tray)

In a case where the grill 16 is to be used in the cooking device 1 so that the cooking device 1 heats a food item placed on the grill 16, the grill 16 is placed on the holding frame 15. In such a case, each of the lateral downwardly raised parts 16c of the grill 16 is inserted between a corresponding one of grill holding parts 15e and a corresponding one of tray holding parts 15d of the holding frame 15. This holds the grill 16 on the holding frame 15 in a state in which the grill 16 is less likely to move.

Meanwhile, in a case where the cooking tray 17 is to be used in the cooking device 1 so that the cooking device 1 heats a food item placed on the cooking tray 17, the cooking tray 17 is placed on the holding frame 15. In such a case, outer surfaces of the cooking tray 17 are brought into contact with the frame front part 15a, frame rear part 15b, and tray holding part 15d of the holding frame 15 to perform positioning of the cooking tray 17.

(Operation of Drive Mechanism)

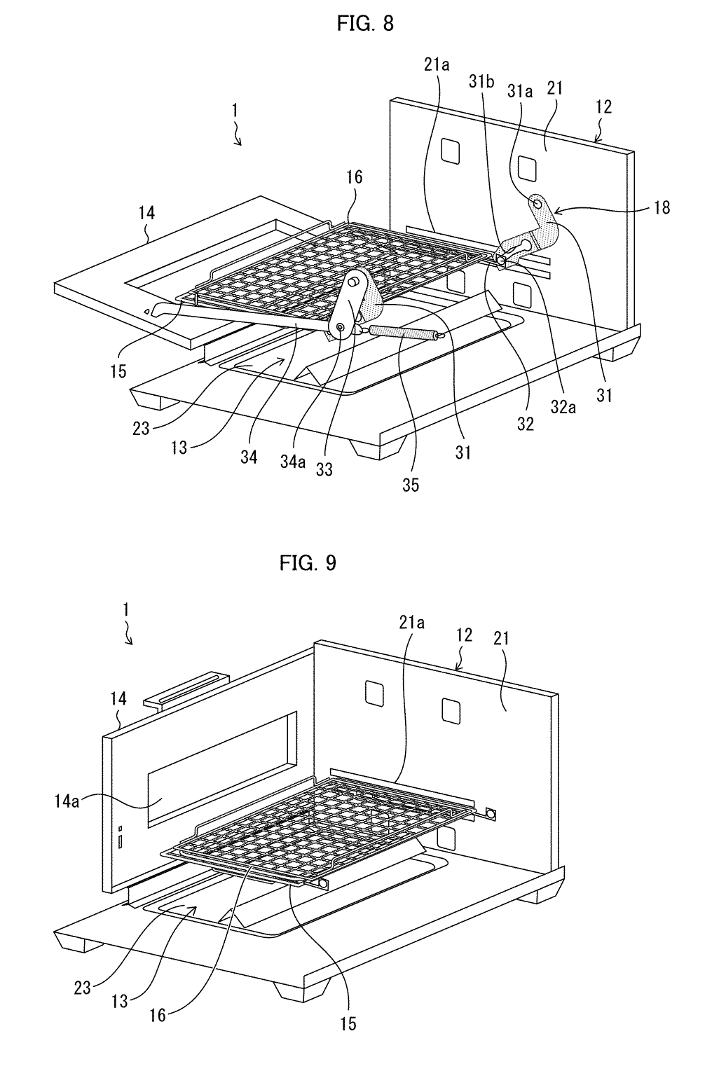

FIG. 8 is a perspective view illustrating the cooking device 1 with the front door 14 in an open position, when viewed at an angle from above and behind.

When the front door 14 in a closed position as illustrated in FIG. 2 is moved into an open position as illustrated in FIGS. 1 and 8, swinging of the front door 14 into an open position pulls and moves the connecting bars 34 forward and expands the coil springs 35. The forward movement of the connecting bars 34 causes the straight levers 33 with their lower parts connected to the connecting bars 34 to rotate forward, and causes the L-shaped levers 31 to rotate forward together with the straight levers 33. Then, by being pushed by the L-shaped levers 31 (ends of the long holes 31b), the engagement protrusions 32a of the engagement member 32, i.e., the holding frame 15, are moved forward. Thus, the holding frame 15 advances through the openings 24a of the front frame 24 from within the cooking room 13. In such a case, movement of the holding frame 15 is guided by the guide grooves 21a.

In such a case, if the food carrying member (grill 16 or cooking tray 17) is placed on the holding frame 15, the food carrying member advances together with the holding frame 15. In this state, it is possible to easily perform placement of the grill 16 or the cooking tray 17 on the holding frame 15, replacement between the grill 16 and the cooking tray 17, and placement of a food item on the grill 16 or the cooking tray 17.

Next, when the front door 14 in an open position is moved into a closed position, swinging of the front door 14 into a closed position pushes and moves the connecting bars 34 rearward and contracts the coil springs 35. The rearward movement of the connecting bars 34 causes the straight levers 33 to rotate rearward, and causes the L-shaped levers 31 to rotate rearward together with the straight levers 33. Then, by being pushed by the L-shaped levers 31 (ends of the long holes 31b), the engagement protrusions 32a of the engagement members 32, i.e., the holding frame 15, are moved rearward and retracted into the cooking room 13.

(Advantages of Cooking Device)

The cooking device 1 is configured such that the guide grooves 21a for guiding movement of the holding frame 15 are provided without having holes that pass through the side walls 21. Further, the upper heater attachment holes 21b and the lower heater attachment holes 21c of the side walls 21 are blocked by provision of the upper heaters 19 and the lower heater 20. Still further, the connecting bar through holes 24b are blocked by the front door 14 when the front door 14 is in a closed position. Yet further, the side walls 21 have no holes or openings that pass through the side walls 21 and are kept open.

Particularly, the cooking device 1 is configured such that the guide grooves 21a are provided without having any holes that pass through the side walls 21, and the drive mechanism 18 drives the holding frame 15 without the need to form any normally open holes or openings through the side walls 21.

Thus, the cooking device 1 eliminates the need for any holes formed through the side walls 21, such as normally open guide grooves. With this configuration, it is possible to prevent, during cooking of a food item, leakage of hot air in the cooking room 13 through the inner walls 12 into a wall-to-wall space between the inner walls 12 and the outer walls. This allows the cooking device 1 to prevent a decrease in heating efficiency during cooking of a food item. This also allows the cooking device 1 to prevent an insanitary condition that can arise when any pieces of food are flown out of the cooking room 13 into the wall-to-wall space and are accumulated in the wall-to-wall space.

Further, the cooking device 1 can prevent, during cooking of the food item in the cooking room 13, leakage of steam from a food item into the wall-to-wall space. Thus, it is possible to prevent corrosion or short-circuit of a current-carrying part which normally present in the wall-to-wall space due to moisture of the steam.

Note that, in Embodiment 1, the drive mechanism 18 is configured such that the straight levers 33, the connecting bars 34, and the coil springs 35 are provided on outer surfaces of the side walls 21, i.e., in the wall-to-wall space between the inner walls 12 and the outer walls. Such a configuration allows the cooking room 13 to be simplified with few constituent parts of the drive mechanism 18. This makes it possible to easily keep the cooking room 13 sanitary. Alternatively, the drive mechanism 18 may be configured such that the straight levers 33, the connecting bars 34, and the coil springs 35 are provided on inner surfaces of the side walls 21, i.e., in the cooking room 13. In such a configuration, no connecting bar through holes 24b are provided in the front frame 24 while many constituent parts of the drive mechanism 18 are present in the cooking room 13. This makes it possible to further increase airtightness of the cooking room 13.

Note that the cooking device 1 in accordance with Embodiment 1 is configured such that the holding frame 15 on which the food carrying member (grill 16 or cooking tray 17) is placed is driven by the drive mechanism 18 so that the holding frame 15 is moved in a state of being guided by the guide grooves 21a, and the food carrying member is moved accordingly. However, the configuration of the cooking device 1 is not limited to such a configuration. Alternatively, the cooking device 1 may be configured such that the holding frame 15 is not present, and the food carrying member (grill 16 or cooking tray 17) is driven by the drive mechanism 18 so as to be moved in a state of being guided by the guide grooves 21a. This also applies to other embodiments (Embodiments 3 and 4) described below.

### Embodiment 21

The following description will discuss another embodiment of the present invention with reference to the drawings. For convenience of explanation, members having functions identical to those of members described in Embodiment 1 are given the same reference signs, and the descriptions thereof are omitted.

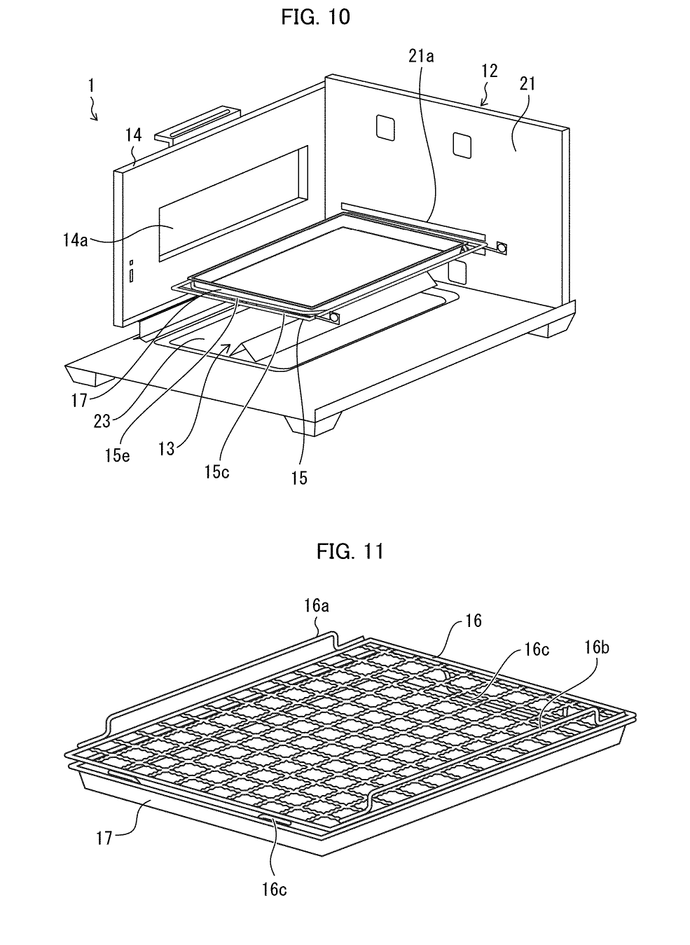

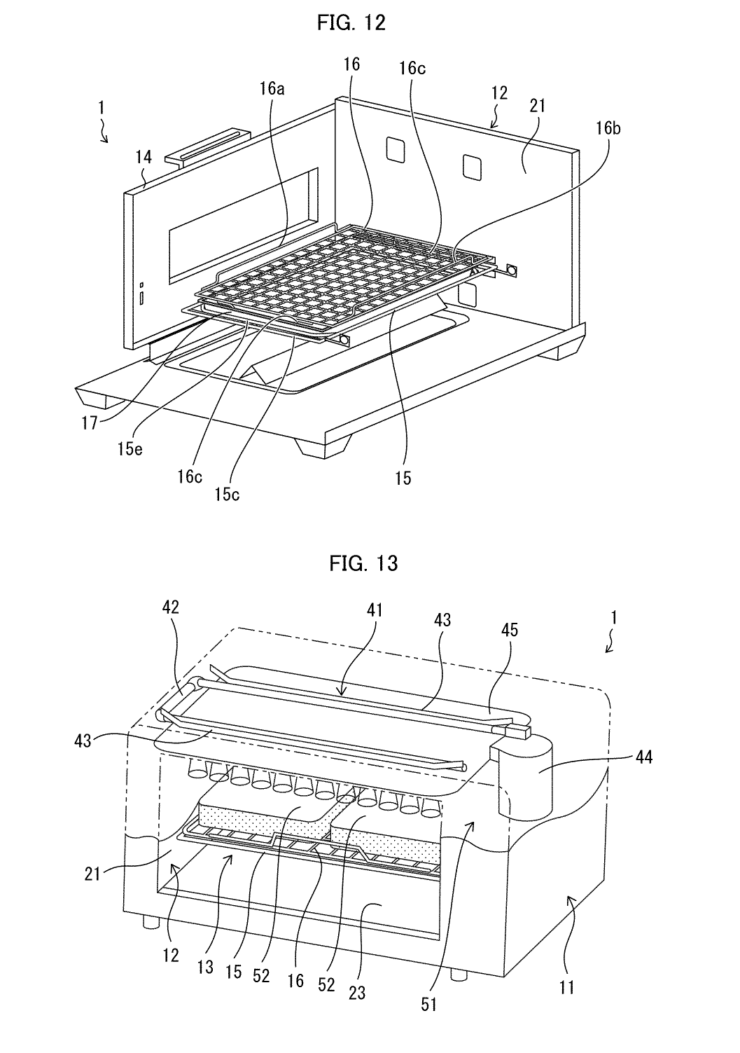

FIG. 9 is a perspective view illustrating a cooking device 1 in accordance with Embodiment 2 in a state in which the grill 16 is placed on the holding frame 15. FIG. 10 is a perspective view illustrating the cooking device 1 in accordance with Embodiment 2 in a state in which the cooking tray 17 is placed on the holding frame 15. FIG. 11 is a perspective view illustrating a state in which the grill 16 is placed on the cooking tray 17. FIG. 12 is a perspective view illustrating the cooking device 1 in accordance with Embodiment 2 in a state in which the cooking tray 17 and the grill 16 in the state illustrated in FIG. 11 is placed on the holding frame 15. Note that, for simplicity of drawings, FIGS. 9, 10, and 12 omit the drive mechanism 18.

As in the case of the cooking device 1 in accordance with Embodiment 1, the cooking device 1 in accordance with Embodiment 2 includes the holding frame 15, the guide grooves 21a, and the drive mechanism 18.

The cooking device 1 in accordance with Embodiment 2 is configured such that the grill 16 and the cooking tray 17 can be used independently of each other as illustrated in FIGS. 9 and 10, and such that the grill 16 and the cooking tray 17 can be used in a state in which the grill 16 is placed on the cooking tray 17 as illustrated in FIGS. 11 and 12. In this case, in the state illustrated in FIG. 11, the lateral downwardly raised parts 16c of the grill 16 are placed inside the cooking tray 17 in such a manner as to be aligned on corresponding left and right side surfaces of the cooking tray 17. In this case, positioning of the grill 16 on the cooking tray 17 is successfully performed in a case where a positional relation between the left and right side surfaces of the cooking tray 17 and the lateral downwardly raised parts 16c of the cooking tray 17 is preset so that the lateral downwardly raised parts 16c provided on the left and right sides of the grill 16 are fit with the left and right side surfaces of the cooking tray 17. Alternatively, the cooking device 1 in accordance with Embodiment 2 may be simply configured such that the left and right lateral downwardly raised parts 16c of the grill 16 can be inserted in a space between the left and right side surfaces of the cooking tray 17. Such a configuration eliminates the interference between the lateral downwardly raised parts 16c and the cooking tray 17 and thus allows the grill 16 to be easily placed on the cooking tray 17.

Further, the grill 16 may include, in addition to the lateral downwardly raised parts 16c, a front lateral downwardly raised part and a rear lateral downwardly raised part, both of which correspond to the lateral downwardly raised parts 16c, wherein the front lateral downwardly raised part and the rear lateral downwardly raised part are provided respectively on the front and rear sides of the grill 16. Such a configuration allows the cooking device 1 to further enhance the capability of performing positioning of the grill 16 with respect to the cooking tray 17.

(Advantages of Cooking Device)

The cooking device 1 in accordance with Embodiment 2 is configured such that the cooking tray 17 and the grill 16 can be placed on the holding frame 15 in a state in which the grill 16 is placed on the cooking tray 17. The use of the cooking tray 17 and the grill 16 in such a state is suitable for heating of fried food put on the grill 16. Specifically, excess oil coming out of fried food during heating of the fried food falls into the cooking tray 17. In such a case, the oil in the cooking tray 17 and the fried food will never be brought into contact with each other, and the oil coming out of the fried food will never be returned to the fried food. Thus, the cooking device 1 is capable of heating fried food to a good condition without causing the oil coming out of the fried food to be returned to the fried food during heating of the fried food.

Further, the grill 16 can be used in a state of being directly placed on the holding frame 15 and can also be used in a state of being placed on the cooking tray 17. This eliminates the need for an additional grill dedicated to placement on the cooking tray 17, thus enabling reduction of the number of components and cost reduction.

Further, the lateral downwardly raised parts 16c can be used for positioning of the grill 16 with respect to the holding frame 15 and can also be used for positioning of the grill 16 with respect to the cooking tray 17. This enables simplification of the structure of the grill 16.

Further, by arranging the lengthwise and breadthwise dimensions of the grill 16 (lengthwise dimension refers to a dimension between the front upwardly raised part 16a and the rear upwardly raised part 16b) so as to be smaller than those of the cooking tray 17, it is possible to ensure the fall of oil coming out of fried food placed on the grill 16 into the cooking tray 17.

### Embodiment 31

The following description will discuss yet another embodiment of the present invention with reference to the drawings. For convenience of explanation, members having functions identical to those of members described in Embodiments 1 and 2 are given the same reference signs, and the descriptions thereof are omitted.

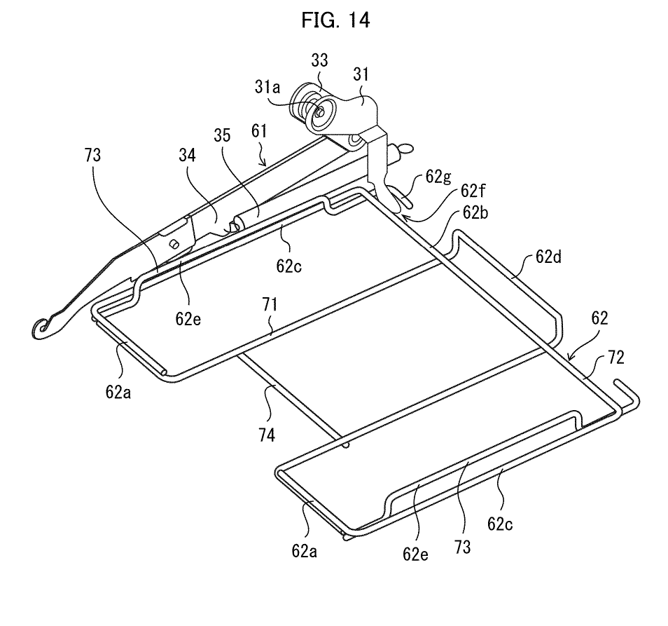

FIG. 13 is a perspective view illustrating a cooking device 1 in accordance with Embodiment 3 in a state in which the front door 14 is removed. As illustrated in FIG. 13, the cooking device 1 in accordance with Embodiment 3 includes a heating device 41 instead of the upper heater 19. Note that as in the case of the cooking device 1 in accordance with Embodiments 1 and 2, the cooking device 1 in accordance with Embodiment 3 includes the lower heater 20 provided below the holding frame 15. FIG. 13 illustrates, as an example, a case where the cooking device 1 is a toaster oven that heats a sliced bread 52 on the grill 16 which is placed on the holding frame 15.

The cooking device 1 has inner walls 12 on the inner side of the outer walls 11 constituting the housing of the cooking device 1, and has the wall-to-wall space 51 between the outer walls 11 and the inner walls 12. The heating device 41 includes a heating tube 42 and a sheathed heater 43. The heating tube 42 is closed at one end which serves as a blocked part, and is connected to a steam generating device 44 at the other end. The steam generating device 44 is located in the wall-to-wall space 51. The sheathed heater 43 heats the heating tube 42 so that steam in the heating tube 42 is heated so as to be turned into high temperature steam (e.g. superheated steam).

The heating tube 42 is provided on a top plate 45 constituting a top wall of the cooking room 13, and has multiple steam injecting holes (not illustrated), provided on the lower surface of the heating tube 42 (i.e., at positions facing the top plate 45), for injecting steam in the heating tube 42. To correspond to these steam injecting holes, the top plate 17 has multiple steam injecting holes provided therein.

The steam generating device 44 takes in water to generate steam, and then supplies the steam thus generated to the heating tube 42. Other features of the configuration of the cooking device 1 are the same as the features of the configuration of the cooking device 1 described in Embodiments 1 and 2.

(Operation of Cooking Device)

In a case where a sliced bread 52 placed on the grill 15 is to be heated on both sides in the cooking device 1, the heating device 41, the lower heater 20, and the steam generating device 44 are operated. In such a case, the upper side of the sliced bread 52 is heated by radiant heat and superheated stream from the heating device 41, and the lower side of the sliced bread 52 is heated by radiant heat from the lower heater 20. Thus, heating of the sliced bread 52 is finished in a short time.

(Advantages of Cooking Device)

As described earlier, the cooking device 1 in accordance with Embodiment 3 eliminates the need for any holes formed through the side walls 21, such as normally open guide grooves, and it is thus possible to prevent, during cooking of a food item, leakage of hot air and steam filled in the cooking room 13 through the inner walls 12 into the wall-to-wall space 51. Particularly, for a cooking device in which steam is used to heat a food item as in the cooking device 1 in accordance with Embodiment 3, it is important to have a configuration that makes steam less likely to leak through the inner walls 12 into the wall-to-wall space 51. This is because leakage of steam through the inner walls 12 into the wall-to-wall space 51 tends to cause an adverse effect such as corrosion and/or short circuit of a current-carrying part provided in the wall-to-wall space 51. Thus, the configuration in which the cooking device 1 includes the guide grooves 21a and the drive mechanism 18 and does not have any holes formed through the side walls 21, such as normally open guide grooves, is particularly effective for the configuration in which the cooking device 1 includes the heating device 41 that generates steam. Other advantages of the cooking device 1 are the same as the advantages of the cooking devices 1 described earlier.

### Embodiment 41

The following description will discuss yet another embodiment of the present invention with reference to the drawings. For convenience of explanation, members having functions identical to those of members described in Embodiments 1, 2, and 3 are given the same reference signs, and the descriptions thereof are omitted.

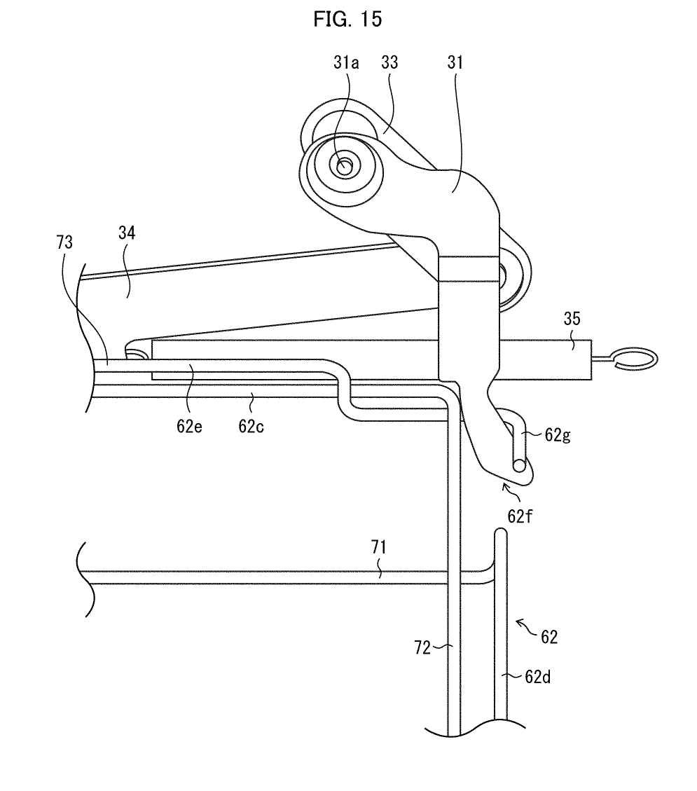

FIG. 14 is a perspective view illustrating a drive mechanism 61 and a holding frame 62 both of which are included in a cooking device 1 in accordance with Embodiment 4. FIG. 15 is an enlarged perspective view illustrating the structure of a connecting part between the drive mechanism 61 and the holding frame 62 illustrated in FIG. 14.

(Configuration of Holding Frame)

As illustrated in FIG. 14, the holding frame 62 is formed by, for example, a combination of a n-shaped member 71, a C-shaped member 72, lateral upwardly raised part forming members 73 on the left and right sides, and a straight line-shaped member 74.

The π-shaped member 71 is arranged such that leg parts extending to the left and right in the letter π correspond to front-edge parts of the holding frame 62, and a rear-edge part of the holding frame 62 is protruded upward to form a rear upwardly raised part 62d of the holding frame 62. The C-shaped member 72 is arranged such that parts close to an opening of the letter C are provided on the π-shaped member 71 so as to correspond to the front-edge parts of the holding frame 62, specifically so as to be aligned with the leg parts extending to the left and right in the letter π. Thus, the π-shaped member 71 and the C-shaped member 72 form frame front parts 62a (frame front parts 62a on the left and right) of the holding frame 62, and the C-shaped member 72 forms a frame rear part 62b and frame lateral parts 62c of the holding frame 62.

The lateral upwardly raised part forming members 73 are provided respectively on the inner sides of the left and right frame lateral parts 62c, which are formed by the C-shaped member 72, so as to come into line with the left and right frame lateral parts 62c. Each of the lateral upwardly raised part forming members 73 has a front edge-side part and a rear edge-side part which are located beneath the C-shaped member 72. Each of the lateral upwardly raised part forming members 73 has a middle part which is protruded upward to form a corresponding one of lateral upwardly raised parts 62e of the holding frame 62. The rear edge-side parts of the lateral upwardly raised part forming members 73 are bent toward the opposite lateral upwardly raised part forming members 73 at a given distance from the frame rear part 62b. The bent portions are rear engaging parts 62g, and spaces between the rear engaging parts 62g and the frame rear part 62b are lever end inserted areas 62f.

The straight line-shaped member 74, which is provided beneath the π-shaped member 71, couples and reinforces the parts of the π-shaped member 71 which parts extend parallel to each other in the front-to-rear direction.

The holding frame 62 is configured, as in the holding frame 15 described earlier, such that the frame lateral parts 62c are fit into the guide grooves 21a. Thus, the holding frame 62 can be guided by the guide grooves 21a so as to be freely moved in the front-to-rear direction of the cooking device 1.

(Configuration of Drive Mechanism)

As illustrated in FIGS. 14 and 15, the drive mechanism 61 includes L-shaped levers (first members) 31, straight levers (second members) 33, connecting bars (third member) 34, and coil springs 35, as in the drive mechanism 18 described earlier. Note that in the drive mechanism 61, the L-shaped levers 31 are connected to the holding frame 62 through insertion of the lower ends of the L-shaped levers 31 into the corresponding lever end inserted areas 62f of the holding frame 62. Further, each of the connecting bars 34 is made up of two parts, i.e., a front-side part and a rear-side part, and is formed by connecting a rear end portion of the front-side part to a front end portion of the rear-side part. Other features of the configuration of the drive mechanism 61 are the same as the features of the configuration of the drive mechanism 18.

(Operation of Drive Mechanism)

The operation of the drive mechanism 61 is substantially the same as that of the drive mechanism 18 described earlier. The operation of the drive mechanism 61 differs from that of the drive mechanism 18 in the following points. That is, while the front door 14 is moved into an open position, the frame rear part 62b of the holding frame 62 is pushed by the lower ends of the L-shaped levers 31, so that the holding frame 62 is moved forward. Similarly, while the front door 14 is moved into an open position, the frame rear part 62b of the holding frame 62 is pushed by the lower ends of the L-shaped levers 31, so that the holding frame 62 is moved rearward.

(Configuration of Grill and Arrangement for Preventing Movement of Grill)

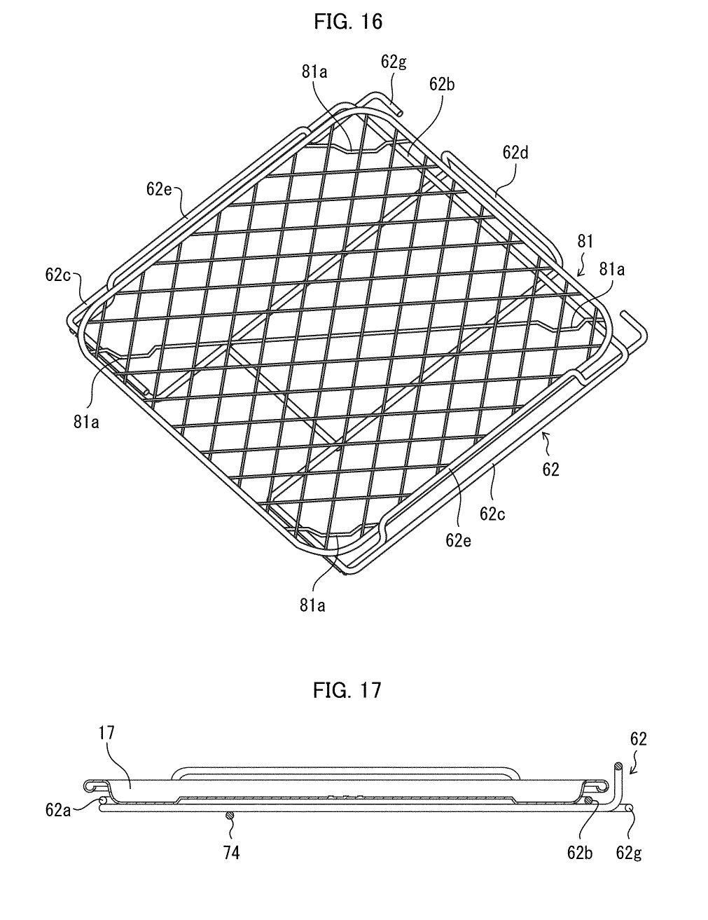

FIG. 16 is a perspective view illustrating a state in which a grill 81, which serves as a food carrying member, is placed on the holding frame 62. The grill 81 of the cooking device 1 in accordance with Embodiment 4 is configured to have no upwardly raised part, by virtue of the left and right lateral upwardly raised parts 62e and the rear upwardly raised part 62d of the holding frame 62. Meanwhile, positioning of the grill 81 is performed in a state in which the grill 81 is placed on the holding frame 62, and the grill 81 has a plurality of downwardly raised parts 81a for preventing movement of the grill 81. In a state in which the grill 81 is placed on the holding frame 62, each of the downwardly raised parts 81a is arranged so as to fit into a space between adjacent frame parts of the holding frame 62, thereby preventing movement of the grill 81 with respect to the holding frame 62.

(Arrangement for Preventing Movement of Cooking Tray)

FIG. 17 is a longitudinal sectional view illustrating a state in which a cooking tray 17, which serves as a food carrying member, is placed on the holding frame 62. As illustrated in FIG. 17, the cooking tray 17 in a state of being placed on the holding frame 62 is arranged such that outer surfaces of the cooking tray 17 fit in a region surrounded by the frame front parts 62a (π-shaped member 71), frame rear part 62b, and left and right lateral upwardly raised parts 62e of the holding frame 62. With this arrangement, movement of the cooking tray 17 is prevented in a state in which the cooking tray 17 is placed on the holding frame 62.

(Advantages of Cooking Device)

Advantages of the cooking device 1 in accordance with Embodiment 4 are the same as the advantages of the cooking devices 1 in accordance with Embodiments 1, 2, and 3.

### [Recap]

A cooking device in accordance with a first aspect of the present invention is a cooking device including (i) a heating device (upper heaters 19, lower heaters 20) configured to heat an interior of a cooking room 13 and (ii) a door (front door 14) configured to swing about a lower portion of the door to open and close the interior of the cooking room 13, the cooking device including: guide grooves 21a, provided on two opposite side walls 21 of the cooking room 13, extending in a front-to-rear direction; a food carrying member (grill 16, cooking tray 17) configured to be moved in a state of being guided by the guide grooves 21a or a holding frame 15 on which the food carrying member is to be placed; first members (L-shaped levers 31), provided on the corresponding side walls 21, having their respective first ends and second ends, the first ends having respective rotation centers 31a about which the first members rotate, the second ends being connected to the food carrying member or the holding frame 15; second members (straight levers 33), provided on the corresponding side walls 21, having their respective first ends, the first ends having respective rotation centers 33a about which the second members rotate, the rotation centers 33a being in agreement with the rotation centers 31a of the first members, the rotation centers 33a being secured together with the first members (L-shaped levers 31); and third members (connecting bars 34) having their respective first ends and second ends, the first ends being connected to the door (front door 14), the second ends being connected to the corresponding second ends of the second members (straight levers 33).

According to the above configuration, when the door in a closed position is moved into an open position, swinging of the door into an open position pulls and moves the third members forward (i.e., toward the door), the second members are rotated forward, and the first members are rotated forward together with the second members. This causes the food carrying member or the holding frame connected to the first members to be moved forward in a state of being guided by the guide grooves. In this situation, in a case where the food carrying member is being placed on the holding frame, the food carrying member is moved forward together with the holding frame. Note that a food item to be cooked is placed on the food carrying member.

On the other hand, when the door in an open position is moved into a closed position, swinging of the door into a closed position pushes and moves the third members rearward, the second members are rotated rearward, and the first members are rotated rearward together with the second members. This causes the food carrying member or the holding frame connected to the first members to be moved rearward in a state of being guided by the guide grooves.

As described above, according to the cooking device, the drive mechanism including the first members, the second members, and the third members is used to move the food carrying member or the holding frame (i.e., the food carrying member placed on the holding frame) in the front-to-rear direction. Thus, the guide grooves for guiding movement of the food carrying member or the holding frame are not required to have any holes passing through the side walls.

Thus, according to the cooking device, it is possible to prevent, during cooking of a food item, leakage of hot air in the cooking room through the inner walls (including the side walls) into a wall-to-wall space between the inner walls and the outer walls. This allows the cooking device to prevent a decrease in heating efficiency during cooking of a food item.

This also allows the cooking device to prevent an insanitary condition that can arise when any pieces of food are flown out of the cooking room into the wall-to-wall space and are accumulated in the wall-to-wall space.

Further, it is possible to prevent corrosion or short-circuit of a current-carrying part which normally present in the wall-to-wall space due to moisture of steam generated from a food item during cooking of the food item and leaked into wall-to-wall space.

In a second aspect of the present invention, the cooking device can be configured such that, in the first aspect of the present invention, the first members (L-shaped levers 31) are provided along corresponding inner surfaces of the side walls 21, the second members (straight levers 33) and the third members (connecting bars 34) are provided along corresponding outer surfaces of the side walls 21, both the first members (L-shaped levers 31) and the second members (straight levers 33) are secured at the respective rotation centers (31a, 33a), and the third members (connecting bars 34) are connected to the door (front door 14), while penetrating a front frame 24 with which the door (front door 14) is in contact when the door (front door 14) is in a closed position.

According to the above configuration, the first members are provided along the corresponding inner surfaces of the side walls 21, and the second members and the third members are provided along the corresponding outer surfaces of the side walls 21. This allows a space surrounded by the inner surfaces of the side walls 21, i.e., the cooking room, to be simplified with few constituent parts of the drive mechanism for driving the holding frame. This makes it possible to easily keep the cooking room sanitary.

In a third aspect of the present invention, the cooking device can be configured such that, in the first or second aspect of the present invention, the heating device comprises a plurality of heating devices at least one of which is a heating device 41 configured to inject stream.

For the cooking device including the heating device 41 which injects steam, it is important to have a configuration that makes steam less likely to leak through the inner walls (including the side walls) into the wall-to-wall space between the inner walls and the outer walls. This is because leakage of steam through the inner walls into the wall-to-wall space tends to cause an adverse effect such as corrosion and/or short circuit of a current-carrying part provided in the wall-to-wall space. Thus, the configuration of the cooking device in which the guide grooves 21a for guiding movement of the food carrying member or the holding frame 15 are not required to have any holes passing through the side walls 21, is particularly effective for the configuration in which the cooking device includes the heating device 41 that generates steam.

In a fourth aspect of the present invention, the cooking device can be configured such that, in any one of the first to third aspects of the present invention, the food carrying member comprises a grill 16 and a cooking tray 17, the grill 16 and the cooking tray 17 are permitted to be placed on the holding frame 15 in a state in which the grill 16 is placed on the cooking tray 17, and the grill 16 includes downwardly raised parts (lateral downwardly raised parts 16c) which serve as positioning parts by which positioning of the grill 16 is performed with respect to the holding frame 15 and the cooking tray 17.

According to the above configuration, the grill 16 and the cooking tray 17 are permitted to be placed on the holding frame 15 in a state in which the grill 16 is placed on the cooking tray 17. In such a placement state, excess oil coming out of fried food during heating of the fried food put on the grill 16 falls into the cooking tray 17. Thus, the fried food will never be brought into contact with the oil in the cooking tray 17, and the oil coming out of the fried food will never be returned to the fried food. Thus, the cooking device is capable of heating fried food to a good condition without causing the oil coming out of the fried food to be returned to the fried food during heating of the fried food.

Further, the grill 16 can be used in a state of being directly placed on the holding frame 15 and can also be used in a state of being placed on the cooking tray 17. This eliminates the need for an additional grill dedicated to placement on the cooking tray 17, thus enabling reduction of the number of components and cost reduction.

Further, the downwardly raised parts of the grill serve as positioning parts by which positioning of the grill is performed with respect to the holding frame 15 and the cooking tray 17. This allows the grill 16 to be placed on the holding frame 15 and the cooking tray 17 in a stable state in which the grill 16 is less likely to move.

In a fifth aspect of the present invention, the cooking device can be configured such that, in the fourth aspect of the present invention, the downwardly raised parts (lateral downwardly raised parts 16c) are provided at left and right edges of the grill 16, the holding frame 15 has downwardly raised part inserted areas which permit the downwardly raised parts (lateral downwardly raised parts 16c) at the left and right edges of the grill 16 to be inserted therein, and the cooking tray 17 is provided so as to permit the downwardly raised parts (lateral downwardly raised parts 16c) at the left and right edges of the grill 16 to be inserted in a space between side surfaces of the cooking tray 17 which side surfaces lie on the left and right sides of the positions corresponding to the downwardly raised parts.

According to the above configuration, the lateral downwardly raised parts 16c can be used for positioning of the grill 16 with respect to the holding frame 15 and can also be used for positioning of the grill 16 with respect to the cooking tray 17. This enables simplification of the structure of the grill 16.

### REFERENCE SIGNS LIST

1: Cooking device
11: Outer wall
12: Inner wall
13: Cooking room
14: Front door
15: Holding frame
15a: Frame front part
15b: Frame rear part
15c: Frame lateral part
15d: Tray holding part
16: Grill (food carrying member)
16a: Front upwardly raised part
16b: Rear upwardly raised part
16c: Lateral downwardly raised part
17: Cooking tray (food carrying member)
18: Drive mechanism
19: Upper heater
20: Lower heater
21: Side wall
21a: Guide groove
21b: Upper heater attachment hole
21c: Lower heater attachment hole
24: Front frame
24a: Opening
24b: Coupling bar through hole
31: L-shaped lever (first member)
32: Engagement member
32a: Engagement protrusion
33: Straight lever (second member)
34: Coupling bar (third member)
35: Coil spring
41: Heating device
42: Heating tube
51: Wall-to-wall space
61: Drive mechanism
62: Holding frame
62a: Frame front part
62b: Frame rear part
62c: Frame lateral part
62d: Rear upwardly raised part
62e: Lateral upwardly raised part
62f: Lever end inserted area
62g: Rear engaging part
71: π-shaped member
72: C-shaped member
73: Lateral upwardly raised part forming member
74: Straight line-shaped member
81: Grill
81a: Downwardly raised part

1. A cooking device including (i) a heating device configured to heat an interior of a cooking room and (ii) a door configured to swing about a lower portion of the door to open and close the interior of the cooking room,
the cooking device comprising:
guide grooves, provided on two opposite side walls of the cooking room, extending in a front-to-rear direction;
a food carrying member configured to be moved in a state of being guided by the guide grooves or a holding frame on which the food carrying member is to be placed;
first members, provided on the corresponding side walls, having their respective first ends and second ends, the first ends having respective rotation centers about which the first members rotate, the second ends being connected to the food carrying member or the holding frame;
second members, provided on the corresponding side walls, having their respective first ends, the first ends having respective rotation centers about which the second members rotate, the rotation centers being in agreement with the rotation centers of the first members, the rotation centers being secured together with the first members; and
third members having their respective first ends and second ends, the first ends being connected to the door, the second ends being connected to the corresponding second ends of the second members.

2. The cooking device according to claim 1, wherein
the first members are provided along corresponding inner surfaces of the side walls,
the second members and the third members are provided along corresponding outer surfaces of the side walls,
both the first members and the second members are secured at the respective rotation centers, and
the third members are connected to the door, while penetrating a front frame with which the door is in contact when the door is in a closed position.

3. The cooking device according to claim 1, wherein
the heating device comprises a plurality of heating devices at least one of which is a heating device configured to inject stream.

4. The cooking device according to claim 1, wherein
the food carrying member comprises a grill and a cooking tray,
the grill and the cooking tray are permitted to be placed on the holding frame in a state in which the grill is placed on the cooking tray, and
the grill includes downwardly raised parts which serve as positioning parts by which positioning of the grill is performed with respect to the holding frame and the cooking tray.

5. The cooking device according to claim 4, wherein
the downwardly raised parts are provided at left and right edges of the grill,
the holding frame has downwardly raised part inserted areas which permit the downwardly raised parts at the left and right edges of the grill to be inserted therein, and
the cooking tray is provided so as to permit the downwardly raised parts at the left and right edges of the grill to be inserted in a space between side surfaces of the cooking tray which side surfaces lie on the left and right sides of the positions corresponding to the downwardly raised parts.
